(19) United States
(12) Patent Application Publication
(10) Pub. No.: US 2026/0040072 A1
(43) Pub. Date: Feb. 5, 2026

(54) SYSTEMS AND METHODS FOR ENABLING SECURE COMMUNICATION BETWEEN SMART CARD AND CORRESPONDING APPLICATION SERVER

(71) Applicant: JIO PLATFORMS LIMITED, Ahmedabad (IN)

(72) Inventors: Dhananjaya LANKALAPALLI, Bangalore (IN); Shyam Sunder MAHESHWARI, Jaipur (IN)

(73) Assignee: JIO PLATFORMS LIMITED, Ahmedabad (IN)

(21) Appl. No.: 18/998,914

(22) PCT Filed: Jul. 14, 2023
(86) PCT No.: PCT/IB2023/057229

§ 371 Date: Jan. 27, 2025

(30) Foreign Application Priority Data
Jul. 26, 2022 (IN) 202221042821

(51) Int. Cl. H04W 12/069

(52) U.S. Cl. CPC H04W 12/069

(57) ABSTRACT

The present disclosure provides a system and a method for enabling secure communication between smart card and corresponding application server. The method includes pushing an applet to one or more smart cards, receiving, from the application server, one or more secure communication keys associated with the one or more smart cards, wherein each of the one or more secure communication keys is based on a unique identifier associated with each of the one or more smart cards, and pushing the received one or more secure communication keys to the corresponding one or more smart cards based on the unique identifier of each of the one or more smart cards.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to a forecasting system. In particular, the present disclosure relates to a forecasting system for predicting device events using artificial intelligence and machine learning based architecture.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In a digital world, with millions of users across the globe, prediction definitely has the power to drive the future of interaction. Feeding a historical dataset into a system that uses machine learning algorithms to predict outcomes makes prediction possible.

People interact with a number of different electronic devices on a daily basis. However, the usefulness of these devices is often limited to basic and/or particular pre-determined tasks associated with the device. With advancements in technology and varied number of devices being deployed, comparatively fewer advancements have been made regarding usage of these devices in diverse or evolving and unpredictable ecosystems.

There is, therefore, a need in the art to provide a method and a system that can overcome the shortcomings of the existing prior arts.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for providing secure communication between one or more smart cards and a corresponding application server. The system includes one or more processors and a memory operatively coupled to the one or more processors, wherein the memory includes processor-executable instructions, which on execution, cause the one or more processors to push an applet to the one or more smart cards, wherein each of the one or more smart cards is associated with a corresponding computing device, receive, from the application server, one or more secure communication keys associated with the one or more smart cards, wherein each of the one or more secure communication keys is based on a corresponding unique identifier associated with each of the one or more smart cards, and push the received one or more secure communication keys to the corresponding one or more smart cards based on the corresponding unique identifier associated with each of the one or more the smart cards.

In some embodiments, the one or more secure communication keys may secure the communication between the application server and the one or more smart cards.

In some embodiments, the one or more smart cards may include at least one of a subscriber identity module (SIM) card, a universal integrated circuit card (UICC), an eUICC, an iSIM, or a universal SIM.

In some embodiments, the unique identifier may include an integrated circuit card identification (ICCID) number, and each of the one or more secure communication keys may include a symmetric key generated based on the ICCID number.

In some embodiments, the processor may be configured to push the applet and the one or more secure communication keys to the one or more smart cards at different instances of time.

In some embodiments, the processor may be configured to push the applet along with each of the one or more secure communication keys to the corresponding each of the one or more smart cards.

In another aspect, the present disclosure relates to a method for providing secure communication between one or more smart cards and a corresponding application server. The method includes pushing, by one or more processors, an applet to the one or more smart cards, wherein each of the one or more smart cards is associated with a corresponding computing device, receiving, by the one or more processors, from the application server, one or more secure communication keys associated with the one or more smart cards, wherein each of the one or more secure communication keys is based on a corresponding unique identifier associated with each of the one or more smart cards, and pushing, by the one or more processors, the received one or more secure communication keys to the corresponding one or more smart cards based on the corresponding unique identifier of each of the one or more smart cards.

In some embodiments, the method may include pushing, by the one or more processors, the applet and the one or more secure communication keys to the one or more smart cards at different instances of time.

In some embodiments, the method may include pushing, by the one or more processors, the applet along with each of the one or more secure communication keys to the corresponding each of the one or more smart cards.

In one another aspect, the present disclosure relates to a method for provisioning one or more secure communication keys to an applet in one or more smart cards. The method may include obtaining, by an application server, a predefined state of the applet in each of the one or more smart cards, and providing, by the application server, the one or more secure communication keys to the applet in each of the one or more smart cards based on the predefined state of the applet.

In yet another aspect, the present disclosure relates to a user equipment (UE) with a smart card. The UE includes one or more processors communicatively coupled to a system, wherein the one or more processors are operatively coupled to a memory including processor-executable instructions, which on execution, cause the one or more processors to receive an applet on the smart card associated with the UE, receive a unique secure communication key associated with a unique identifier of the smart card, and communicate securely with an application server corresponding to the applet based on the received unique secure communication key.

In yet another aspect, the present disclosure relates to a non-transitory computer readable medium that includes one or more instructions stored thereupon that when executed by a processor causes the processor to push an applet to one or more smart cards, wherein each of the one or more smart cards is associated with a corresponding computing device, receive, from an application server, one or more secure communication keys associated with the one or more smart cards, wherein each of the one or more secure communication keys is based on a corresponding unique identifier associated with each of the one or more smart cards, and push the received one or more secure communication keys to the corresponding one or more smart cards based on the corresponding unique identifier of each of the one or more smart cards.

### OBJECTS OF THE PRESENT DISCLOSURE

Some of the objects of the present disclosure, which at least one embodiment herein satisfies are as listed herein below.

An object of the present disclosure is to enable secure communication between a newly installed client (Applet) on a subscriber identity module (SIM) card and an application server.

An object of the present disclosure is to provide symmetric keys for the communication between the newly installed client and the application server over a SIM over the air (OTA) platform. 3G/4G SIM cards are capable of symmetric cryptography. If SIM card is capable of asymmetric cryptography (RSA, ECC or any other) like 5G SIM card with SUCI calculation capability, then asymmetric key pair and certificates can be generated and pushed by SIM OTA platform to newly installed SIM Applet client. This Public or Private Key along with its certificate can be used for mutual authentication between SIM Client Applet and its Application server, and later generation of symmetric secure communication keys. Certificates and Keys (public or private) can be managed by KMS and securely provisioned by SIM OTA to the newly installed SIM Client. KMS shall manage CA and generate required keys/certificates which are signed by same CA (same certificate chain) and can be pushed to SIM Client and Application server.

An object of the present disclosure is to facilitate a unique ciphering key for each newly installed client on the SIM card and the application server for secure communication.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary network architecture (100) in which or with which a proposed system may be implemented, in accordance with an embodiment of the present disclosure.

FIG. 2 illustrates an exemplary representation (200) of the proposed system for enabling secure communication between a subscriber identity module (SIM) client and a corresponding application server, in accordance with an embodiment of the present disclosure.

FIG. 3 illustrates an exemplary representation (300) for enabling secure communication between a newly installed SIM client and the corresponding application server, in accordance with an embodiment of the present disclosure.

FIG. 4 illustrates an exemplary process representation (400) for enabling secure communication between the newly installed SIM client and the corresponding application server through a key management system (KMS), in accordance with an embodiment of the present disclosure.

FIG. 5 illustrates an exemplary flow diagram of a method (500) for enabling secure communication between the newly installed SIM client and the corresponding application server, in accordance with an embodiment of the present disclosure.

FIG. 6 illustrates an exemplary computer system (600) in which or with which embodiments of the present disclosure may be implemented.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a robust and an effective solution for enabling secure communication between a newly installed subscriber identity module (SIM) client or an applet on a SIM card with a corresponding application server. In an embodiment, a SIM over the air (OTA) platform initially pushes the SIM client to the SIM card and enables transferring a unique secure communication key from the application server to the SIM client. The unique secure communication key may include a symmetric key providing secure communication between each SIM client and the application server. In some embodiments, the unique key may be based on an Integrated Circuit Card Identification Number (ICCID) number associated with the SIM card. In some embodiments, the application server may generate the symmetric key and send it to the SIM OTA platform, wherein the SIM OTA platform may push the secure communication key to the SIM card. In some embodiments, a key management server may generate the secure communication key and transfer it to the application server and to the SIM OTA platform.

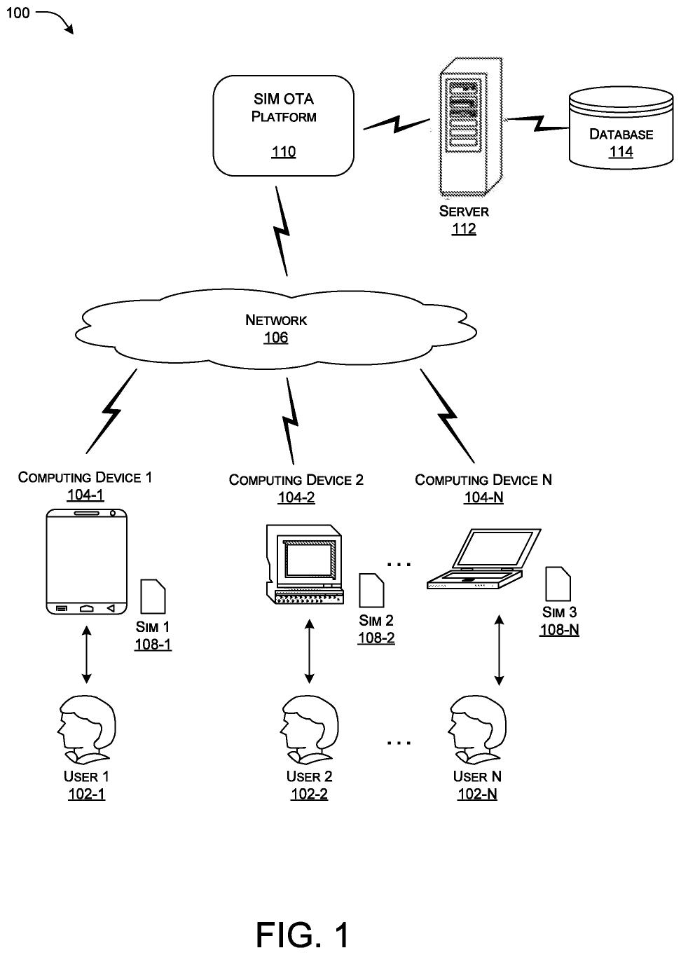

The various embodiments throughout the disclosure will be explained in more detail with reference to FIGS. 1-6.

FIG. 1 illustrates an exemplary network architecture (100) in which or with which embodiments of the present disclosure may be implemented.

Referring to FIG. 1, the network architecture (100) may include one or more computing devices (104-1, 104-2 . . . 104-N) associated with one or more users (102-1, 102-2 . . . 102-N) deployed in an environment, wherein each computing device (104-1, 104-2 . . . 104-N) may include a smart card (108-1, 108-2 . . . 108-N), respectively. The smart card (108-1, 108-2 . . . 108-N) may include, for example, without limitations, at least one of SIM card, universal integrated circuit card (UICC), or a universal SIM. A person of ordinary skill in the art will understand that one or more users (102-1, 102-2 . . . 102-N) may be individually referred to as the user (102) and collectively referred to as the users (102). Further, a person of ordinary skill in the art will understand that one or more computing devices (104-1, 104-2 . . . 104-N) may be individually referred to as the computing device (104) and collectively referred to as the computing devices (104). Furthermore, a person of ordinary skill in the art will understand that one or more smart cards (108-1, 108-2 . . . 108-N) may be individually referred to as the smart card (108) and collectively referred to as the smart cards (108). It may be appreciated that the terms smart card and SIM card may be used interchangeably throughout the disclosure.

In an embodiment, each computing device (104) may interoperate with every other computing device (104) in the network architecture (100). In an embodiment, the computing devices (104) may be referred to as a user equipment (UE). A person of ordinary skill in the art will appreciate that the terms “computing device(s)” and “UE” may be used interchangeably throughout the disclosure.

In an embodiment, the computing devices (104) may include, but are not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device (104) with wireless communication capabilities, and the like. In an embodiment, the computing devices (104) may include, but are not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device (104) may include one or more in-built or externally coupled accessories including, but not limited to, a visual aid device such as camera, audio aid, a microphone, a keyboard, and input devices for receiving input from a user (102) such as touch pad, touch enabled screen, electronic pen, and the like.

In an embodiment, the computing devices (104) may include smart devices operating in a smart environment, for example, the IoT system. In such an embodiment, the computing devices (104) may include, but are not limited to, smart phones, smart watches, smart sensors (e.g., mechanical, thermal, electrical, magnetic, etc.), networked appliances, networked peripheral devices, networked lighting system, communication devices, networked vehicle accessories, smart accessories, tablets, smart television (TV), computers, smart security system, smart home system, other devices for monitoring or interacting with or for users (102) and/or places, or any combination thereof. In an embodiment, the computing devices (104) may include one or more of the following components: sensor, radio frequency identification (RFID) technology, GPS technology, mechanisms for real-time acquisition of data, passive or interactive interface, mechanisms of outputting and/or inputting sound, light, heat, electricity, mechanical force, chemical presence, biological presence, location, time, identity, other information, or any combination thereof.

A person of ordinary skill in the art will appreciate that the computing devices (104) may include, but not be limited by, intelligent, multi-sensing, network-connected devices, that can integrate seamlessly with each other and/or with a central server or a cloud-computing system or any other device that is network-connected.

A person of ordinary skill in the art will appreciate that the computing devices or UEs (104) may not be restricted to the mentioned devices and various other devices may be used.

Referring to FIG. 1, the computing devices (104) may communicate with a system (110), for example, a SIM OTA platform, through a network (106). In an embodiment, the network (106) may include at least one of a Second Generation (2G), Third Generation (3G), Fourth Generation (4G) network, a Fifth Generation (5G) network, or the like. The network (106) may enable the computing devices (104) to communicate between devices (104) and/or with the system (110). As such, the network (106) may enable the computing devices (104) to communicate with other computing devices (104) via a wired or wireless network. The network (106) may include a wireless card or some other transceiver connection to facilitate this communication. In an exemplary embodiment, the network (106) may incorporate one or more of a plurality of standard or proprietary protocols including, but not limited to, Wi-Fi, Zigbee, or the like. In another embodiment, the network (106) may be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or the like.

Referring to FIG. 1, the system or the SIM OTA platform (110) may be operatively coupled to a server (112). In an embodiment, the SIM OTA platform (110) may push SIM client or an applet from the server (112) to the SIM card (108) in the computing device (104). In an embodiment, the server (112) may include an application server, and the SIM OTA platform (110) may push the applet from the application server (112) to the SIM card (108). In some embodiments, the server (112) may generate a unique key or a secure communication key for securing communication between the applet in each SIM card (108) and the server (112) based on an ICCID associated with the SIM card (108). The server (112) may communicate the generated unique keys to the SIM OTA platform (110), wherein the SIM OTA platform (110) may push the unique keys to the SIM card (108).

Referring to FIG. 1, the server (112) may be connected to a database (114). In an embodiment, the database (114) may store the unique keys generated by the server (112). The database (114) may be within the server (112) or may be external to the server (112).

In some embodiments, the SIM OTA platform (110) may push the applet and the secure communication key at different time instances to the SIM card (108). In some embodiments, the SIM OTA platform (110) may push the applet and the secure communication at the same time instant to the SIM card (108).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

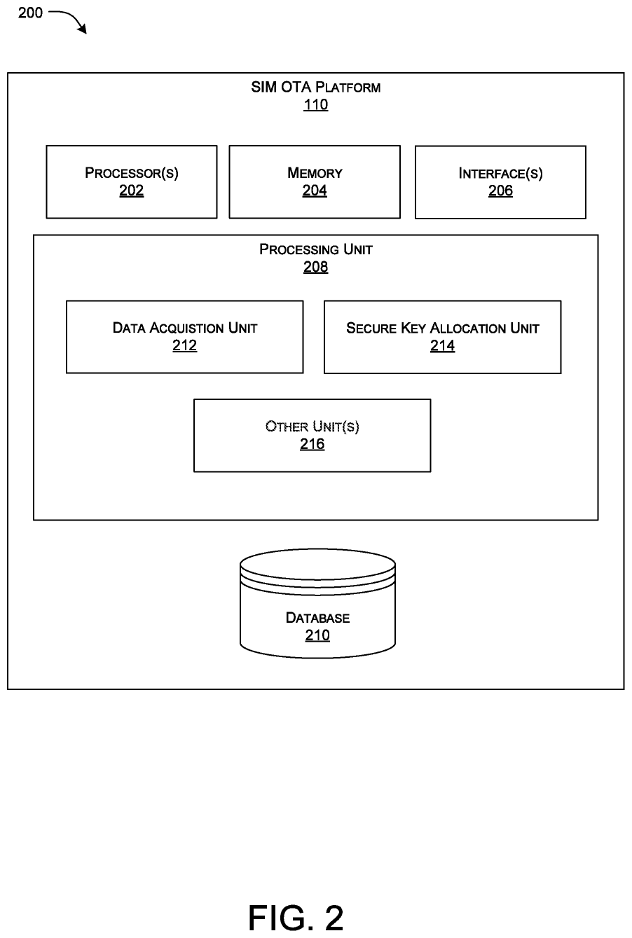

FIG. 2 illustrates an exemplary representation (200) of the proposed system for enabling secure communication between a SIM client and a corresponding application server. in accordance with an embodiment of the present disclosure.

Referring to FIG. 2, the system or the SIM OTA platform (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (110) may include an interface(s) (206). The interface(s) (206) may comprise a variety of interfaces, for example, interfaces for data input and output devices, referred to as input/output (I/O) devices, storage devices, and the like. The interface(s) (206) may facilitate communication for the system (110). The interface(s) (206) may also provide a communication pathway for one or more components of the system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing unit(s) (208). In examples described herein, such combinations of hardware and programming may be implemented in several different ways. For example, the programming for the processing unit(s) (208) may be processor-executable instructions stored on a non-transitory machine-readable storage medium and the hardware for the processing unit(s) (208) may comprise a processing resource (for example, one or more processors), to execute such instructions. In the present examples, the machine-readable storage medium may store instructions that, when executed by the processing resource, implement the processing unit(s) (208). In such examples, the system (110) may include the machine-readable storage medium storing the instructions and the processing resource to execute the instructions, or the machine-readable storage medium may be separate but accessible to the system (110) and the processing resource. In other examples, the processing unit(s) (208) may be implemented by electronic circuitry. In an aspect, the database (210) may comprise data that may be either stored or generated as a result of functionalities implemented by any of the components of the processor (202) or the processing units (208).

In an embodiment, the processing unit (208) may include one or more modules/units such as, but not limited to, a data acquisition unit (212), a secure key allocation unit (214), and other units(s) (216).

Referring to FIG. 2, the database (210) may store ICCID data associated with one or more SIM cards (108). In an embodiment, the database (210) may or may not reside in the SIM OTA platform (110). In an embodiment, the SIM OTA platform (110) may be operatively coupled with the database (210).

In an embodiment, the one or more processor(s) (202) of the system (110) may cause the data acquisition unit (212) to acquire the ICCID number associated with a particular SIM card (108) as shown in FIG. 1, from the database (210). Further, the processor(s) (202) may cause the secure key allocation unit (214) to allocate the key associated with a particular ICCID to the corresponding SIM card (108). The key may enable secure communication between the applet in the SIM card (108) and a corresponding application server (112), as shown in FIG. 1.

A person of ordinary skill in the art will appreciate that the exemplary representation (200) may be modular and flexible to accommodate any kind of changes in the system (110).

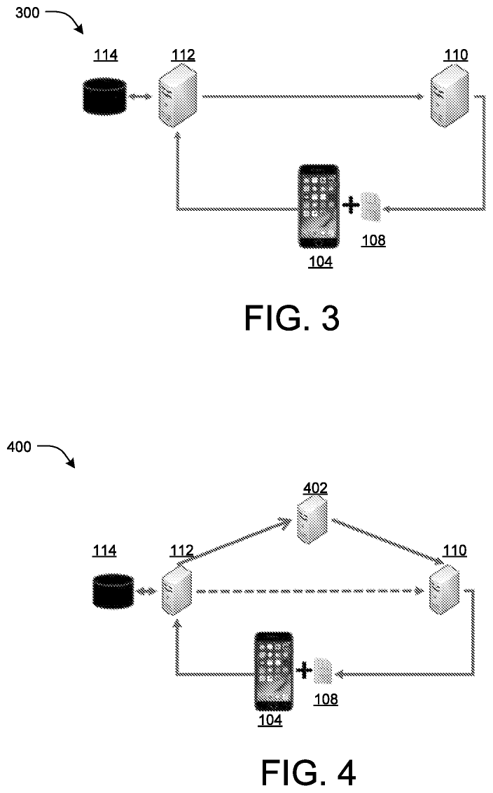

FIG. 3 illustrates an exemplary representation (300) for enabling secure communication between a newly installed SIM client and the corresponding application server, in accordance with an embodiment of the present disclosure.

Referring to FIG. 3, the SIM OTA platform (110) may push a new SIM client or an applet to the one or more SIM cards (108) associated with one or more UEs (104), respectively.

In some embodiments, the applet may be configured with an internet protocol (IP) address/port or a short code or a fully qualified domain name (FQDN) associated with the corresponding application server (112). The applet or SIM client may then start periodic polling of unsecure handshakes with the corresponding application server (112). The application server (112), upon receiving the unsecure polls, may generate a symmetric transport layer security (TLS) key for each applet or SIM client based on a unique ICCID associated with the respective SIM card (108). The application server (112) may further store the generated symmetric TLS key in the database (114) and communicate the same to the SIM OTA platform (110) along with the ICCID of the SIM card (108) on which the applet is installed. In an embodiment, the database (114) may be within the application server (112). In another embodiment, the database (114) may be located outside the application server (112) and be communicatively coupled with the application server (112).

In some embodiments, the generated symmetric TLS key along with the corresponding ICCID may be transmitted to the SIM OTA platform (110). The SIM OTA platform (110) may further push the received symmetric TLS key to the SIM card (108) having the respective ICCID. Upon receiving the symmetric TLS key, the applet on the SIM card (108) may start secure communications with the corresponding application server (112) based on secure channel protocols (SCP) 80 and 81. In some embodiments, SCP 80 may be used for short messaging service (SMS) communication and SCP 81 may be used for hypertext transfer protocol secure (https) communication. On the other hand, until the applet receives the secure communication key from the SIM OTA platform (110), the applet may keep handshaking at certain intervals with the application server (112) in an unsecure way. This unsecure handshaking provides an indication to the application server (112) to push the SIM OTA platform (110) to send the secure communication key to the applet.

From the above discussions, it is apparent that each SIM client or applet may have its unique secure key for communication with the corresponding application server (112) providing an advantage over hacking. For example, if one key may be hacked, then the impact may be on only one client, thereby avoiding compromising security with the entire set of clients.

Referring to FIG. 3, there may be different scenarios requiring the download of applets into the SIM cards. By way of example, without limitations, two such use case scenarios are discussed below.

The first scenario may include a high OTA traffic scenario, where the applet may be downloaded into a large number of SIM cards. In such a scenario, the applet may be pushed to all the SIM cards first followed by pushing the secure communication key based on unsecure polls from each applet with the corresponding application server (112), discussed in detail above with reference to FIG. 3.

The second scenario may include a low OTA traffic scenario, where number of targeted SIM cards to which the applet needs to be downloaded is less or need based. In such a scenario, when there is a need to push the applet to the SIM card, the application server (112) may generate the symmetric TLS key or secure communication key and communicate the generated secure communication key to the SIM OTA platform (110) along with the corresponding ICCID. The SIM OTA platform (110) may push the applet along with the secure communication key to the SIM cards having the respective ICCID. The applet or SIM client may then start communicating with the corresponding application server (112) using the secure communication key. By way of example, without limitations, the application server (112) may make a JavaScript Object Notation (JSON) call to the SIM OTA platform (110) with the ICCID of the SIM card (108) and the generated secure communication key.

FIG. 4 illustrates an exemplary representation (400) for enabling secure communication between the newly installed SIM client and the corresponding application server through a key management system (KMS), in accordance with an embodiment of the present disclosure.

Referring to FIG. 4, the KMS (402) may assist the application server (112) in generating the secure communication key. In some embodiments, the KMS (402) may generate the secure communication key based on the ICCID or a Mobile Station International Subscriber Directory Number (MSISDN) and share the generated key with the application server (112) and the SIM OTA platform (110). The SIM OTA platform (110) may further push the received secure communication key to the SIM card (108) associated with the UE (104) along with the required applet. The applet may then initiate secure communications with the corresponding application server (112) using the received secure communication key. In some embodiments, the application server (112) may receive the secure communication key from the KMS (402) and store it in the database (114).

3G/4G SIM cards are capable of symmetric cryptography. If SIM card is capable of asymmetric cryptography (RSA, ECC or any other) like 5G SIM card with SUCI calculation capability, then asymmetric key pair and certificates can be generated and pushed by SIM OTA platform to newly installed SIM Applet client. This Public or Private Key along with its certificate can be used for mutual authentication between SIM Client Applet and its

Application server, and later generation of symmetric secure communication keys. Certificates and Keys (public or private) can be managed by KMS and securely provisioned by SIM OTA to the newly installed SIM Client. KMS shall manage CA and generate required keys/certificates which are signed by same CA (same certificate chain) and can be pushed to SIM Client and Application server.

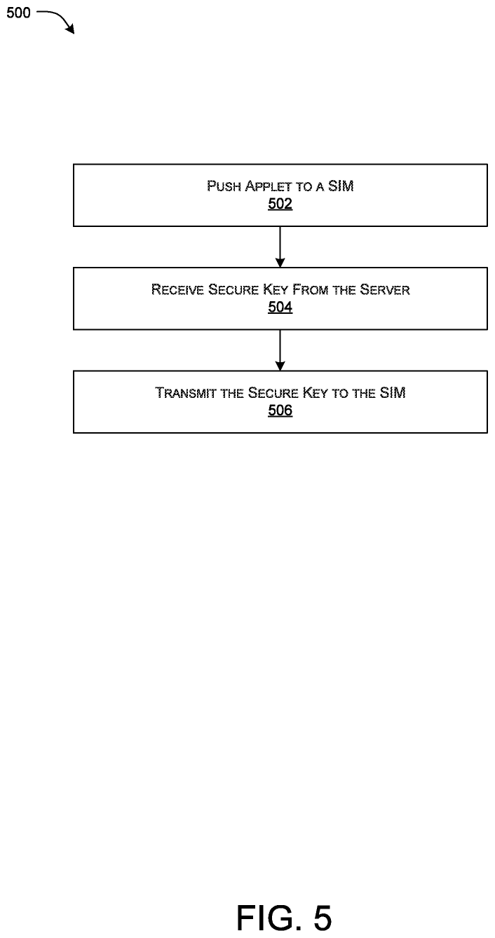

FIG. 5 illustrates an exemplary flow diagram of a method (500) for enabling secure communication between the newly installed SIM client and the corresponding application server, in accordance with an embodiment of the present disclosure.

In some embodiments, the method (500) may be executed at the SIM OTA platform or the system (110), as shown in FIG. 1 or FIG. 2. Referring to FIG. 5, the method (500) may include, at step 502, pushing a new applet for installation in a SIM card (108) as shown in FIG. 1, wherein the SIM card (108) may be associated with a computing device or UE (104). Further, the method (500) may include, at step 504, receiving a secure communication key from the application server (112) as shown in FIG. 1, wherein the secure communication key may include a symmetric TLS key for enabling secure communication between the application server (112) and the newly installed applet. The method (500) may further include, at step 506, pushing the received secure communication key to the applet.

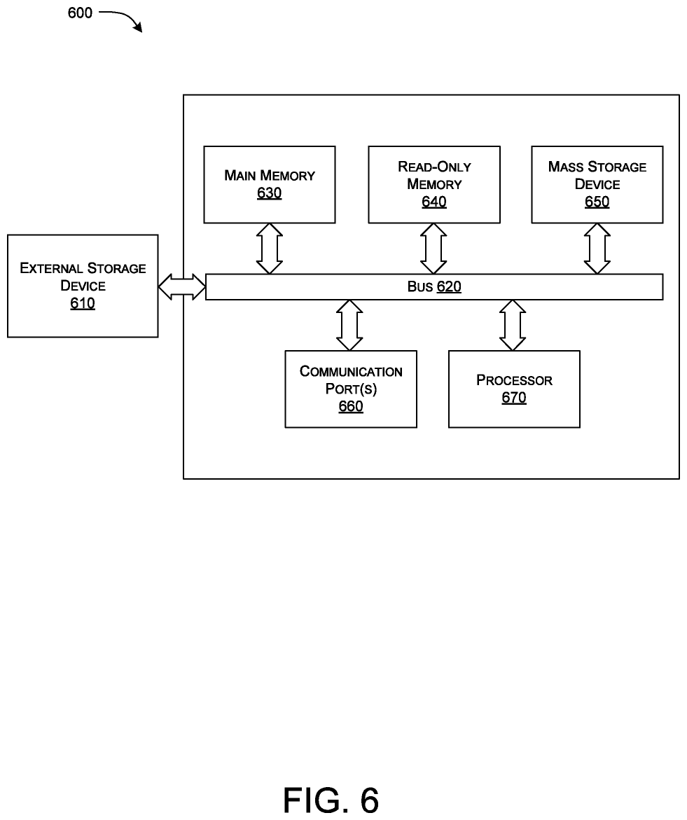

FIG. 6 illustrates an exemplary computer system (600) in which or with which embodiments of the present disclosure may be utilized.

As shown in FIG. 6, the computer system (600) may include an external storage device (610), a bus (620), a main memory (630), a read-only memory (640), a mass storage device (650), communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (660) may be chosen depending on a network, such a Local Area Network (LAN), Wide Area Network (WAN), or any network to which the computer system (600) connects. The main memory (630) may be random access memory (RAM), or any other dynamic storage device commonly known in the art. The read-only memory (640) may be any static storage device(s) including, but not limited to, a Programmable Read Only Memory (PROM) chips for storing static information e.g., start-up or basic input/output system (BIOS) instructions for the processor (670). The mass storage device (650) may be any current or future mass storage solution, which may be used to store information and/or instructions.

The bus (620) communicatively couples the processor (670) with the other memory, storage, and communication blocks. The bus (620) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (670) to the computer system (600).

Optionally, operator and administrative interfaces, e.g. a display, keyboard, and a cursor control device, may also be coupled to the bus (620) to support direct operator interaction with the computer system (600). Other operator and administrative interfaces may be provided through network connections connected through the communication port(s) (660). In no way should the aforementioned exemplary computer system (600) limit the scope of the present disclosure.

Thus, the present disclosure enables providing individual security keys to each applet installed in each UE. Therefore, a security compromise in any of the security key affects only the respective applet in contrast to the single key system followed in the prior art where the compromise in security affects the complete set of downloaded applets.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a secure communication between a newly installed client (Applet) on a subscriber identity module (SIM) card and an application server.

The present disclosure provides symmetric keys for the communication between the newly installed client and the application server over a SIM over the air (OTA) platform.

The present disclosure facilitates a unique ciphering key for each newly installed client on the SIM card and the application server for secure communication.

We claim:

1. A system (110) for providing secure communication between one or more smart cards (108) and a corresponding application server (112), said system (110) comprising:
one or more processors (202); and
a memory (204) operatively coupled to the one or more processors (202), wherein the memory (204) comprises processor-executable instructions, which on execution, cause the one or more processors (202) to:
push an applet to the one or more smart cards (108), wherein each of the one or more smart cards (108) is associated with a corresponding computing device (104);
receive, from the application server (112), one or more secure communication keys associated with the one or more smart cards (108), wherein each of the one or more secure communication keys is based on a corresponding unique identifier associated with each of the one or more smart cards (108); and
push the received one or more secure communication keys to the corresponding one or more smart cards (108) based on the corresponding unique identifier of each of the one or more smart cards (108).

2. The system (110) as claimed in claim 1, wherein the one or more secure communication keys secure the communication between the application server (112) and the one or more smart cards (108).

3. The system (110) as claimed in claim 1, wherein the one or more smart cards (108) comprise at least one of: a subscriber identity module (SIM) card, a universal integrated circuit card (UICC), or a universal SIM.

4. The system (110) as claimed in claim 1, wherein the unique identifier comprises an integrated circuit card identification (ICCID) number.

5. The system (110) as claimed in claim 4, wherein each of the one or more secure communication keys is a symmetric key generated based on the ICCID number.

6. The system (110) as claimed in claim 1, wherein the memory (204) comprises processor-executable instructions, which on execution, cause the one or more processors (202) to push the applet and the one or more secure communication keys to the one or more smart cards (108) at different instances of time.

7. The system (110) as claimed in claim 1, wherein the memory (204) comprises processor-executable instructions, which on execution, cause the one or more processors (202) to push the applet along with each of the one or more secure communication keys to the corresponding one or more smart cards (108).

8. A method (500) for providing secure communication between one or more smart cards (108) and a corresponding application server (112), the method (500) comprising:
pushing, by one or more processors (202), an applet to the one or more smart cards (108), wherein each of the one or more smart cards (108) is associated with a corresponding computing device (104);
receiving, by the one or more processors (202), from the application server (112), one or more secure communication keys associated with the one or more smart cards (108), wherein each of the one or more secure communication keys is based on a corresponding unique identifier associated with each of the one or more smart cards (108); and
pushing, by the one or more processors (202), the received one or more secure communication keys to the corresponding one or more smart cards (108) based on the corresponding unique identifier of each of the one or more smart cards (108).

9. The method (500) as claimed in claim 8, wherein the one or more secure communication keys secure the communication between the application server (112) and the one or more smart cards (108).

10. The method (500) as claimed in claim 8, wherein the unique identifier comprises an integrated circuit card identification (ICCID) number.

11. The method (500) as claimed in claim 10, wherein each of the one or more secure communication keys is a symmetric key generated based on the ICCID number.

12. The method (500) as claimed in claim 8, comprising:
pushing, by the one or more processors (202), the applet and the one or more secure communication keys to the one or more smart cards (108) at different instances of time.

13. The method (500) as claimed in claim 8, comprising:
pushing, by the one or more processors (202), the applet along with each of the one or more secure communication keys to the corresponding each of the one or more smart cards (108).

14. A method for provisioning one or more secure communication keys to an applet in one or more smart cards (108), said method comprising:
obtaining, by an application server (112), a predefined state of the applet in each of the one or more smart cards (108); and
providing, by the application server (112), the one or more secure communication keys to the applet in each of the one or more smart cards (108) based on the predefined state of the applet.

15. A user equipment (UE) (104) with a smart card (108), said UE (104) comprising:
one or more processors communicatively coupled to a system (110), wherein the one or more processors are operatively coupled to a memory comprising processor-executable instructions, which on execution, cause the one or more processors to:
receive an applet on the smart card (108) associated with the UE (104);
receive a unique secure communication key associated with a unique identifier of the smart card (108); and
communicate securely with an application server (112) corresponding to the applet based on the received unique secure communication key.

16. A non-transitory computer readable medium that comprises one or more instructions stored thereupon that when executed by a processor causes the processor to:
push an applet to one or more smart cards (108), wherein each of the one or more smart cards (108) is associated with a corresponding computing device (104);
receive, from an application server (112), one or more secure communication keys associated with the one or more smart cards (108), wherein each of the one or more secure communication keys is based on a corresponding unique identifier associated with each of the one or more smart cards (108); and
push the received one or more secure communication keys to the corresponding one or more smart cards (108) based on the corresponding unique identifier of each of the one or more smart cards (108).
